(19) United States
(12) Patent Application Publication
(10) Pub. No.: US 2009/0327949 A1
(43) Pub. Date: Dec. 31, 2009

(54) INTERACTIVE OVERLAY WINDOW FOR A VIDEO DISPLAY

(75) Inventors: Deepakumar Subbian, Bangalore (IN); Mayur S. Salgar, Bangalore (IN); Marine Drive, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/147,144

(22) Filed: Jun. 26, 2008

(51) Int. Cl. G06F 3/048

(52) U.S. Cl. 715/781

(57) ABSTRACT

The present invention relates to video displays for surveillance camera systems, and in particular, to an overlay window and associated method for interacting with a video display. The overlay window comprises a plurality of geometric areas overlying video data containing a plurality of objects displayed on a video display. Each object is associated with at least one geometric area that is responsive to an input for generating a response from the associated object.

### FIELD OF THE INVENTION

The present invention relates to video displays for surveillance camera systems, and in particular, to a overlay window and associated method for interacting with a video display.

### BACKGROUND OF THE INVENTION

Video surveillance systems are used in a variety of applications for monitoring objects within an environment, e.g., a piece of baggage in an airport, a casino employee within a gambling establishment, or a secured access point of a building. Video surveillance has long been employed in the aviation industry to monitor the presence of individuals at key locations within an airport, such as at security gates, baggage area, parking garages, etc. Analog closed circuit television (CCTV), and more recently available digital, network-based video surveillance systems are employed to monitor and/or track individuals and objects, vehicles entering or leaving a building facility or security gate (entry/exit), individuals present within, entering/exiting a store, casino, office building, hospital, etc., or other known settings where the health and/or safety of the occupants may be of concern.

Typically, such video surveillance systems include multiple video cameras located at multiple locations within a secured premises or perimeter. As such, operators or security personnel frequently monitor multiple views derived from multiple cameras. It is often difficult for operators to quickly interact with the different security features (e.g., a door, a camera or a security gate) displayed on the display device. For example, in surveillance applications running in full screen with touch screen interface capabilities, operators typically need to use multiple buttons to perform a number of different actions. In one case, an operator may be monitoring a door, and want to know all the people who entered through the door in a given time period. Current interface systems require the operator to run an attendance report, note down names, times of access, and other details. This is a time consuming operation, which takes the attention of the operator away from the live scene.

Therefore, what is needed in the art is a system and a method that enables association of an interactive object with a selection on a video display for more effective surveillance monitoring.

### BRIEF SUMMARY OF THE INVENTION

In one exemplary embodiment, the invention is directed to a method for interacting with a video display, the method comprising providing a user interface including a video display for displaying video data containing a plurality of objects and generating an overlay window over the video data. The overlay window defines the video data into a plurality of geometric areas. Each of the plurality of objects is associated with at least one of the plurality of geometric areas. An input is provided to at least one of the geometric areas to select the object associated therewith. A response is then generated from the selected object.

In one embodiment of the invention, the response from the selected object includes at least one of operating the object and generating data regarding the operation of the object.

In another embodiment of the invention, the generated data is displayed graphically on the video display.

In another embodiment of the invention, the geometric areas are arranged in a generally uniform grid pattern.

In another embodiment of the invention, the geometric areas are generally centered around each of the plurality of objects.

In another embodiment of the invention, providing an input to at least one of the geometric areas further comprises cropping the video data on the video display so as to zoom-in around the selected geometric area.

In another embodiment of the invention, the video display is a touch screen video display.

In another embodiment of the invention, the input is provided by physical contact from a user.

In another exemplary embodiment, the present invention is directed to an overlay window for interacting with a video display. The overlay window comprises a plurality of geometric areas overlying video data containing a plurality of objects displayed on a video display. Each object is associated with at least one geometric area that is responsive to an input for generating a response from the associated object.

In another exemplary embodiment, the present invention is directed to a computer program product, the computer program product comprising: a tangible storage medium readable by a processing circuit and storing instructions for execution by the processing circuit for performing a method for interacting with a video display of a surveillance system. The method comprises generating an overlay window comprising a plurality of geometric areas overlying video data containing a plurality of objects displayed on a video display. The overlay window defines the video data into a plurality of geometric areas. Each of the plurality of objects is associated with at least one of the plurality of geometric areas. An input is provided to at least one of the geometric areas to select the object associated therewith. A response is generated from the selected object.

### BRIEF DESCRIPTION OF THE DRAWINGS

These and other objects, features and advantages of the present invention will become apparent from the following detailed description of illustrative embodiments where, which is to be read in connection with the accompanying drawings, in which:

FIG. 1 illustrates a block diagram of a system for interacting with a video display using an overlay window according to an embodiment of the invention.

FIG. 2 illustrates a user interface including the overlay window shown in FIG. 1, according to an embodiment of the invention.

FIG. 3 illustrates an overlay window according to another embodiment of the invention.

FIG. 4 illustrates a block diagram of a method for interacting with a video display using an overlay window according to an embodiment of the invention

### DETAILED DESCRIPTION OF THE INVENTION

The present invention, which provides an overlay window and associated method for interacting with a video display, will now be described in greater detail by referring to the drawings that accompany the present application. It is noted that the drawings of the present application are provided for illustrative purposes and are thus not drawn to scale.

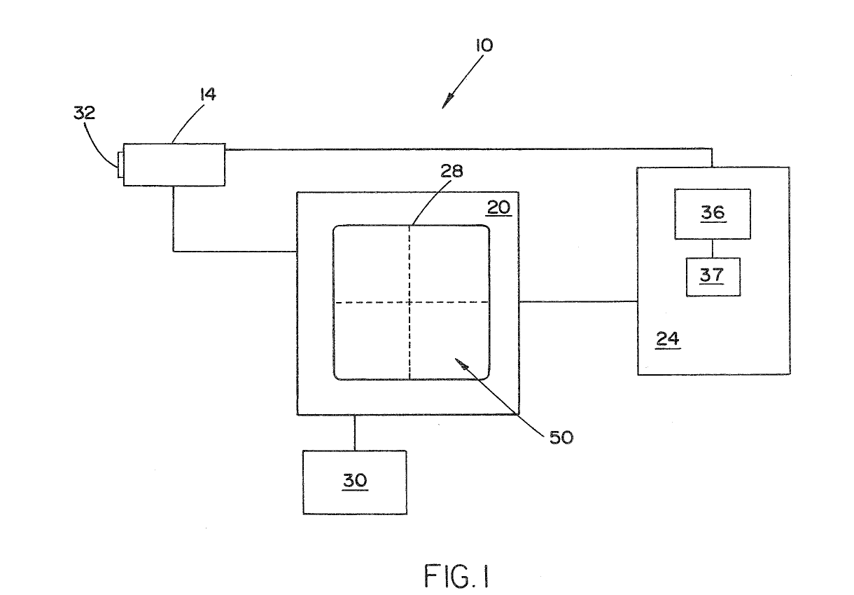

Aspects of the invention will be described first with reference to FIG. 1, which depicts a block diagram illustrating the major components of a system for interacting with a video display (hereinafter “system”) 10 according to the present invention. The system 10 is similar to conventional video surveillance systems used for monitoring an area of interest. As shown, the system 10 includes a user interface 20 having a video display 28 for displaying video data and objects contained in the video data received from a video camera 14. The system 10 includes a processor 24 coupled to the user interface 20, and an optional input device 30, e.g., a mouse or keyboard. As shown on the video display 28, an overlay window 50 having a plurality of geometric areas is provided. As will be further described below, each object in the video data is associated with at least one geometric area of the overlay window 50. The geometric areas are responsive to an input from a user for generating a response from the associated object.

As shown in FIG. 1, the processor 24 of the system 10 is coupled to the user interface 20 for recording and/or displaying the video data on a video display 28. The processor 24 can receive data from the video camera 14 continuously, periodically as programmed, or upon event detection such as by motion detection, audio detection, contact closure or any other triggering event. Data from the video camera 14 may be sent wirelessly using a wireless LAN or WAN connection, such as the Internet. This permits the processor 24 to be connected to the video camera 14 anywhere there is WAN access. Any combination of local (such as Intranet) and remote (such as Internet, frame relay, ISDN, DSL, ADSL, T-1, T-2, OC-3 connected and the like) monitoring stations can be employed. The video camera 14 may also be hardwired (e.g., a fiber optic link or an unshielded twisted pair) to processor 24. It will be understood that any number of surveillance cameras can communicate with the processor 24.

As is known in the art, video camera 14 includes a lens 32 in communication with a sensor and camera processor (not shown) for receiving raw image data from the area of interest and generating video data containing a number of objects in the field of view. The term “video camera” as used herein includes any known video capture or image acquisition device, including digital cameras, digital video recorders, analog CCTV cameras, and other similar devices. Video cameras are typically interfaced directly into an Ethernet-based network at an Ethernet port through a video server. The video camera video outputs may be viewed in their simplest form using the video display 28 of the user interface 20.

The processor 24 shown in FIG. 1 may be any one of a number of conventionally known processors capable of providing the control and data processing functions required by the user interface 20. The processor 24 operates with a memory device 36, which may be a non-volatile storage memory for storing video data and/or image object data, as will be described in more detail below. The memory device 36 can be used for storing programs that enable the user interface 20 to operate with the overlay window 50 and the video data received from the video camera 14.

The processor 24 further includes a database system 37 that operates with the memory device 36. The database system 37 may include any number of local databases necessary for carrying out the present invention. The databases may be arranged in any fashion and may store any desired information (e.g., geometric area information and object information). The databases may include any number of tables containing information regarding the geometric areas, the objects, and the computer programs necessary for generating a response from the object. The tables may include any quantity of keys, where any suitable field may serve as a key for the table. The tables may be related in any suitable fashion and include any quantity of linking fields, where any suitable fields may serve as a linking field between tables. Furthermore, the databases may utilize any suitable query language, where any suitable parameters may be utilized in the queries to retrieve information.

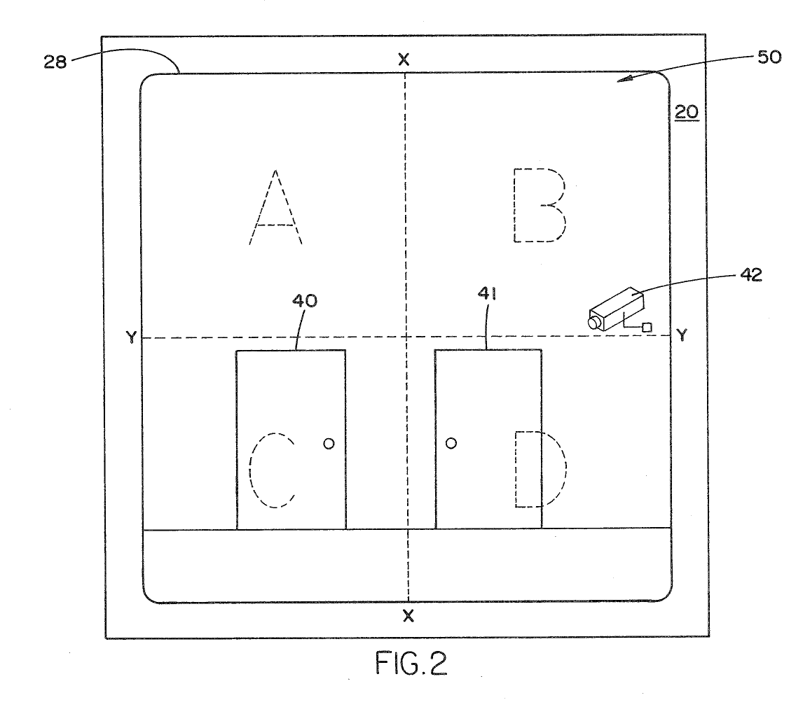

Referring now to FIG. 2, the user interface 20 of the system 10 shown in FIG. 1, as well as a method for interacting with the display 28 using the overlay window 50, will be described in greater detail. As shown, the user interface 20 includes video display 28 for displaying video data containing a plurality of objects 40, 41 and 42. In the exemplary embodiment shown in FIG. 2, the video display 28 is a touch screen video display responsive to physical contact from a user. As is conventionally known, touch screen video displays include means for detecting the presence of a finger touching the video display. However, in another embodiment, the video display 28 may be a conventional, non-touch screen monitor, which operates with an external input device 30 (FIG. 1), such as a mouse or keyboard.

In the exemplary embodiment shown in FIG. 2, the video data displayed by the video display 28 includes a wall of a building comprising objects 40, 41 and 42 (i.e., two access points and a mounted video surveillance camera). As shown, the video data, including the objects 40, 41 and 42, are defined into a plurality of geometric areas by the overlay window 50 that is generated over the video data. Dotted lines X-X and Y-Y split the image data displayed on video display 28 into four geometric areas, which are denoted as A, B, C and D for the sake of explanation. Each of the plurality of objects 40, 41 and 42 is associated with at least one of the plurality of geometric areas A, B, C, or D in the database system 37. As described above, multiple tables in the database system 37 link together each geometric area with data regarding the associated object, including computer algorithms necessary for generating a response from the object.

During operation, when a user selects a particular geographic area of the overlay window 50, the associated object information and computer algorithm from the database are accessed, and the algorithm is executed by the computer to generate a response. The response can include any number of responses from the objects such as, but not limited to, turning on relays to lock/unlock access points, selecting alternate video surveillance cameras, overlaying data on the video, or any other similar response.

If a user wishes to generate a response from one of the objects 40, 41, 42, the user provides an input to one or more geometric areas A, B, C, or D. For example, if the user wishes to open access point 40, the user provides an input to (i.e., touches or selects) the geometric area C on the overlay window 50. Data regarding associated object 40, including programs necessary for triggering the opening of the access point 40, is accessed via the database system 37.

In another example, the user may wish to select a different surveillance camera to bring up another field of view on the video display 28. The user provides an input to the geometric area B to select an alternate video camera 42, which causes the video data from the alternate video camera 42 to be displayed on the video display 28. Providing the input to the geometric area B may cause the video data to be cropped on the video display 28 so as to zoom-in around the selected geometric area B.

The input can also be used to generate data regarding the operation of the access point 40. For example, an input to the geometric area C may generate a list of all the people going in an out of the access point 40, including associated time/date stamp information. This generated data can be displayed graphically on the video display 28. If the user desires both these responses, that is, if the user wishes to both operate the access point 40 and view operational information regarding the access point 40, it can be appreciated that additional divisions to geometric area C can be added to provide this functionality.

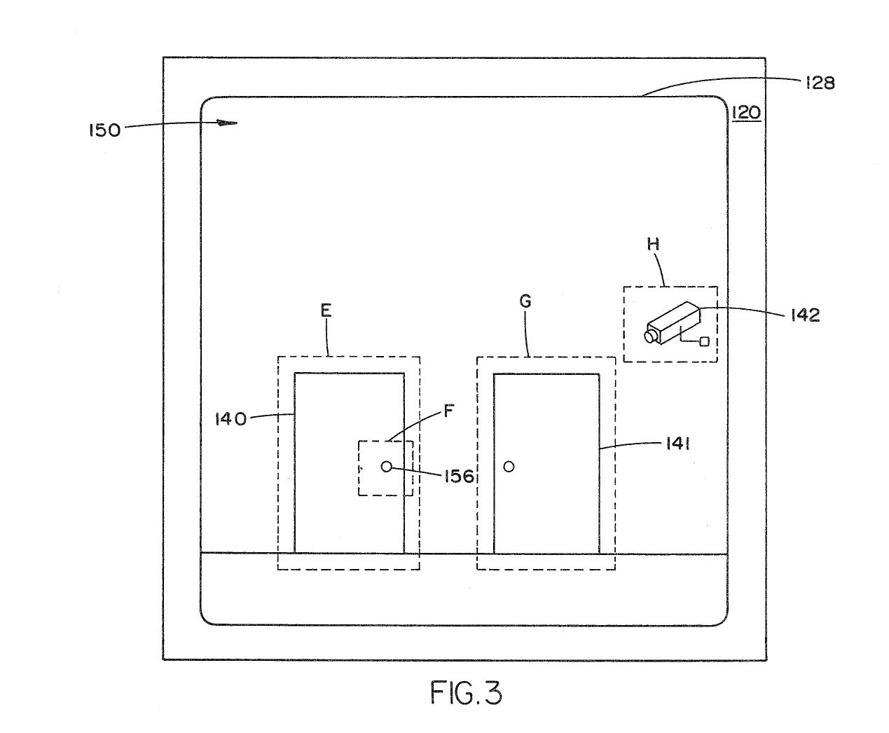

Referring now to FIG. 3, another embodiment of an overlay window 150 is shown. Unlike the embodiment shown in FIG. 2 in which the geometric areas A, B, C, D are arranged in a generally uniform grid pattern, in this embodiment, the geometric areas E, F, G and H are centered around each of the respective objects for greater customization of the overlay window 150. For example, geometric area F is provided around a handle 156 of the access point 140, while geometric area E is provided around the entire access point 140. As such, selection of geometric area F may provide the locking/unlocking function for the access point 140, while selection of geometric area E may generate data to be displayed graphically on the video display 128. It can be appreciated that selection of both geometric areas E and F can generate both responses simultaneously.

Accordingly, the present invention provides an overlay window and associated method for interacting with a video display. The present invention enables association of an interactive object with a selection on a video display. By integrating a number of different objects on the same visual display, operator effectiveness can be increased. Furthermore, the overlay window and method of the present invention can be retrofitted to existing video applications including 3^{rd} party integrations.

As indicated hereinabove, it should be understood that the present invention could be realized in hardware, software, or a combination of hardware and software. Any kind of computer/server system(s)—or other system adapted for carrying out the novel methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

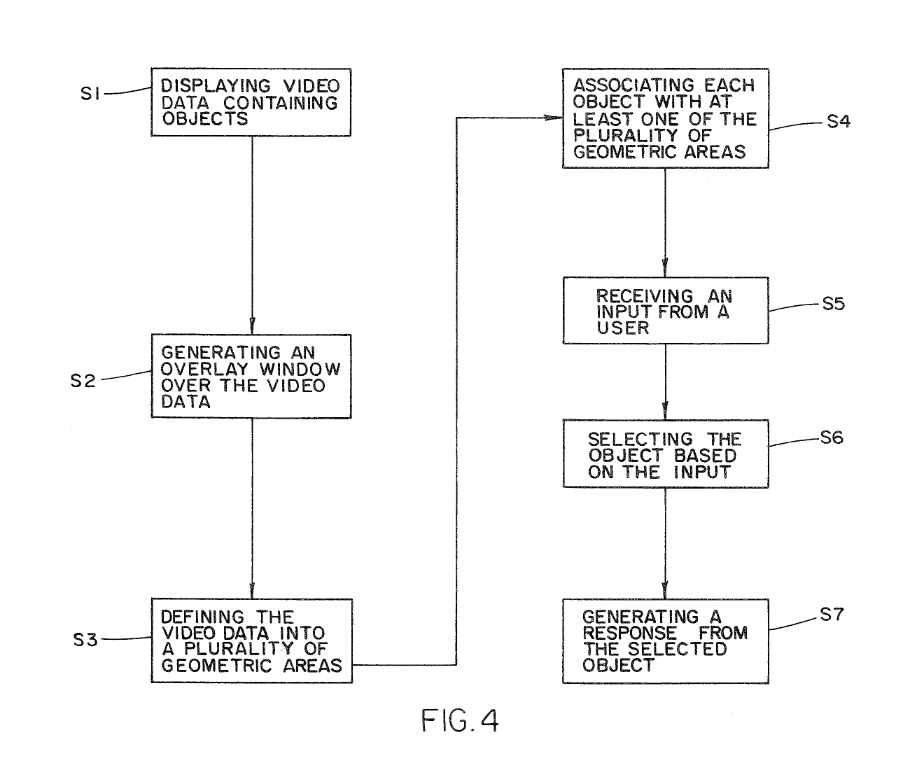

The present invention can also be embodied in a computer program product, which comprises all the respective features enabling the implementation of the methods described herein, for example, the exemplary methods depicted in FIG. 4, and which product—when loaded in a computer system—is able to carry out these and related methods. As shown in FIG. 4, in a first step S1, video data containing a plurality of objects is displayed on a video display of a user interface. In S2, an overlay window is generated over the video. In S3, the overlay window defines the video data into a plurality of geometric areas. In S4, each object is associated with at least one of the plurality of geometric areas. In S5, an input is received from a user, and the object associated therewith is selected in S6. In S7, a response is generated from the selected object. As used herein, computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While the present invention has been described in an illustrative manner, it should be understood that the terminology used is intended to be in a nature of words of description rather than of limitation. Furthermore, while the present invention has been described in terms of illustrative and alternate embodiments, it is to be appreciated that those skilled in the art will readily apply these teachings to other possible variations of the invention. For example, the display device and overlay window of the present invention can be part of personal computer, a minicomputer, a handheld computer, a wearable computing device, a personal digital assistant, a smart appliance in the home, and so forth. Also, although each of the geometric areas shown in FIGS. 1-3 are generally rectangular in shape, it can be appreciated that any 2-D or 3-D shape can be used without departing from the spirit or scope of the invention.

We claim:

1. A method for interacting with a video display, the method comprising:
providing a user interface including a video display for displaying video data containing a plurality of objects;
generating an overlay window over the video data, the overlay window defining the video data into a plurality of geometric areas;
associating each of the plurality of objects with at least one of the plurality of geometric areas;
providing an input to at least one of the geometric areas to select the object associated therewith;
generating a response from the selected object.

2. The method as in claim 1, wherein the response from the selected object includes at least one of operating the object and generating data regarding the operation of the object.

3. The method as in claim 2, wherein the generated data is displayed graphically on the video display.

4. The method as in claim 3, wherein the geometric areas are arranged in a generally uniform grid pattern.

5. The method as in claim 1, wherein the geometric areas are generally centered around each of the plurality of objects.

6. The method as in claim 1, wherein the video display is a touch screen video display.

7. The method as in claim 6, wherein providing an input to at least one of the geometric areas further comprises cropping the video data on the video display so as to zoom-in around the selected geometric area.

8. An overlay window for interacting with a video display, the overlay window comprising a plurality of geometric areas overlying video data containing a plurality of objects displayed on a video display, each object associated with at least one geometric area that is responsive to an input for generating a response from the associated object.

9. The overlay window as in claim 8, wherein the response from the object includes at least one of operating the object and generating data regarding the operation of the object.

10. The overlay window as in claim 8, wherein the generated data is displayed graphically on the video display.

11. The overlay window as in claim 10, wherein the plurality of geometric areas are arranged in a generally uniform grid pattern.

12. The overlay window as in claim 8, wherein the geometric area is generally centered around the associated object.

13. The overlay window as in 8, wherein the video display is a touch screen video display.

14. The overlay window as in claim 13, wherein causes the video data to be cropped on the video display so as to zoom-in around the selected geometric area.

15. The overlay window as in claim 8, wherein the video display is part of a user interface.

16. A computer program product, the computer program product comprising:
a tangible storage medium readable by a processing circuit and storing instructions for execution by the processing circuit for performing a method for interacting with a video display, said method comprising:
generating an overlay window comprising a plurality of geometric areas overlying video data containing a plurality of objects displayed on a video display;
associating each of the plurality of objects with at least one of the plurality of geometric areas;
providing an input to at least one of the geometric areas to select the object associated therewith;
generating a response from the selected object.

17. The computer program of claim 16, wherein the response from the object includes at least one of operating the object and generating data regarding the operation of the object.

18. The computer program of claim 16, wherein the generated data is displayed graphically on the video display.

19. The computer program as in 16, wherein the video display is a touch screen video display.

20. The computer program as in claim 19, wherein providing an input to at least one of the geometric areas further comprises cropping the video data on the video display so as to zoom-in around the selected geometric area.
